(19) United States
(12) Patent Application Publication
(10) Pub. No.: US 2010/0084327 A1
(43) Pub. Date: Apr. 8, 2010

(54) RECOVERY AND PRECIPITATION OF VARIOUS ELEMENTS AND COMPOUNDS

(76) Inventors: Paul Goranson, Corpus Christi, TX (US); Sammy J. Martinez, Encino, TX (US); David Hinojosa, Edinburg, TX (US)

Correspondence Address: DOCKET CLERK, P.O. DRAWER 800889, DALLAS, TX, 75380, US

(21) Appl. No.: 12/561,181

(22) Filed: Sep. 16, 2009

Related U.S. Application Data
(60) Provisional application No. 61/097,454, filed on Sep. 16, 2008.

(51) Int. Cl. B01D 15/08

(52) U.S. Cl. 210/198.2

(57) ABSTRACT

Systems and methods are disclosed for extracting a plurality of materials from a solution. These include a plurality of extraction devices. The extraction devices use a resin suspended above at least one screen, and the resin is used to extract at least one material from a fluid. A liquid is forced through the plurality of extraction devices and a separate material is extracted in each of the extraction devices. The resin is selected for each of the extraction devices and is based upon the material for which that extraction device is designed to remove from the fluid. Each of the extraction devices operate in series to remove at least one material from the fluid.

### CROSS-REFERENCE TO RELATED APPLICATION(S) AND CLAIM OF PRIORITY

The present application is related to U.S. Provisional Patent No. 61/097,454, filed Sep. 16, 2008, entitled “RECOVERY AND PRECIPITATION OF MOLYBDENUM”. Provisional Patent No. 61/097,454 is assigned to the assignee of the present application and is hereby incorporated by reference into the present application as if fully set forth herein. The present application hereby claims priority under 35 U.S.C. §119(e) to U.S. Provisional Pat. No. 61/097,454.

### TECHNICAL FIELD OF THE INVENTION

The present application relates generally to the recovery of certain elements and compounds and, more specifically, to the recovery of elements from various sources using at least one resin.

### BACKGROUND OF THE INVENTION

Valuable elements and compounds may be located in various places. Systems and methods to recover valuable elements from the soil, water, and the atmosphere are needed.

Presently these compounds are mixed in other compounds. For instance, a particular element may be found in soil. However, separating this particular element from the surrounding soil may be difficult, time consuming, or cost prohibitive. Systems and methods that could aid in the recovery of compounds and elements from various sources are needed.

Therefore, there is a need in the art for an improved systems and methods to recover compounds and elements.

### SUMMARY OF THE INVENTION

In one embodiment, a system is disclosed of extracting a plurality of materials from a solution. This system includes a plurality of extraction devices. The extraction devices each use a resin that is suspended above at least one screen and the resin is used to extract at least one material from the fluid. A liquid is forced through the plurality of extraction devices and a separate material is extracted in each of the extraction devices. The resin is selected for each of the extraction devices and is based upon the material for which that extraction device is designed to remove from the fluid. Each of the extraction devices operates in series to remove at least one material from the fluid.

In another embodiment, a method is disclosed that includes selecting a number of extraction apparatuses for extracting a plurality of transitional metals from a fluid, selecting at least one resin for the plurality of extraction apparatuses, moving a liquid through the plurality of extraction apparatuses, and extracting at least one transition metal from the liquid. In addition, this method may include regenerating at least one of the plurality of extraction apparatuses.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a photograph of the pilot plant setup used for this investigation, according to one embodiment of the present disclosure;

FIG. 2 is a chart illustrating loading capacities of Dowex® 21K for molybdenum, according to one embodiment of the present disclosure;

FIG. 3 is a graph illustrating breakthrough concentrations exiting the molybdenum polishing, according to one embodiment of the present disclosure;

FIG. 4 is a graph illustrating the molybdenum loading curves for the molybdenum polishing column are shown, according to one embodiment of the present disclosure;

FIG. 5 is a graph illustrating the sulfate loading curve is shown for the uranium polishing column, according to one embodiment of the present disclosure;

FIG. 6 is a graph illustrating a comparison of the sulfate loading curves for the uranium and molybdenum, according to one embodiment of the present disclosure;

FIG. 7 is a graph illustrating the uranium loading and breakthrough curves are shown for the uranium polishing column, according to one embodiment of the present disclosure;

FIG. 8 is a chart illustrating a comparison of the lbs U/ft3 of resin loaded on the uranium polishing column, according to one embodiment of the present disclosure;

FIG. 9 is a graph illustrating the molybdenum loading and breakthrough concentrations are shown, according to one embodiment of the present disclosure;

FIG. 10 is a chart illustrating the efficiency of each elution was determined for uranium, molybdenum, and sulfates based on the calculated loading of each species per load cycle and the measured concentrations recovered in the eluate, according to one embodiment of the present disclosure;

FIG. 11 is a photograph of the appearance of the ferrimolybdate precipitant as generated at a Ph of 2.3, according to one embodiment of the present disclosure;

FIG. 12 is a graph of beaker test results describing the effect of ph on the recovery of residual molybdenum, according to one embodiment of the present disclosure;

FIG. 13 is a graph of the results of the adsorption isotherm data are shown as a freundlich plot, according to one embodiment of the present disclosure;

FIG. 14 is a graph of the percent molybdenum recovery is shown versus the grams of resin added to the composite east injection water samples, according to one embodiment of the present disclosure;

FIG. 15 is a graph of the percent uranium recovery is shown versus the grams of resin added to the composite water samples, according to one embodiment of the present disclosure;

FIG. 16 is a graph of the percent molybdenum recovery is shown versus the grams of resin added to injection water samples, according to one embodiment of the present disclosure;

FIG. 17 is a graph of the percent uranium recovery is shown versus the grams of resin added to the water samples (not a composite sample), according to one embodiment of the present disclosure; and

FIG. 18 is a flowchart illustrating one method of extracting a transitional metal, according to one embodiment of the present disclosure.

### DETAILED DESCRIPTION OF THE INVENTION

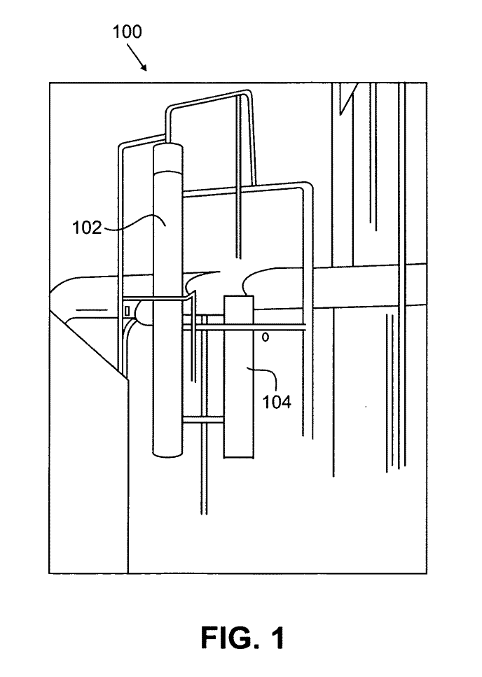

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged to recover elements from various sources.

In some embodiments, systems and methods are disclosed herein that promote extraction of transition metals from various sources. These systems and methods may include steps including determining the loading capacity of a resin comprising a strong base anion with a quaternary amine functional group (such as Dowex 21K® made by Dow Chemical Company), using injection water as the lixiviant. These systems and methods also include using a uranium polishing column to decrease uranium contamination in the eluate. In addition, these methods also may include determining the uranium polishing column's loading and breakthrough characteristics for uranium, molybdenum, and sulfate. When not otherwise specified herein, “resin” is may be used to refer to a resin comprising a strong base anion. Examples of resins are given throughout the present specification. It is contemplated that any resin, or element, structure, or compound capable of performing the functions described herein may be used.

Systems and methods are also disclosed that relate to quantifying the buildup of anions in the eluate and the efficiency of the individual elutions. In addition, these systems and methods further may include precipitating out a ferrimolybdate product for analysis. These systems and methods may be used to extract various elements and compounds, such as transitional metals including, but not limited to, molybdenum.

FIG. 1 is an illustration 100 of one experimental setup that comprises a first polishing column 102 and a second polishing column 104. In this experimental setup, two 8″ diameter PVC test columns, a column 102 and a column 104, as shown in FIG. 1, were constructed. Column 102 was used as a uranium polishing column and column 104 was used as a molybdenum polishing column. The uranium polishing column 102 contained 2 ft3 of resin compared to 1 ft3 for the polishing column 104. Resin was suspended in the columns 102, 104 above the bottom flange using stainless steel or nylon screens. Digital Nu-Flow meters were used to record the volume of fluid passed through the columns 102, 104. Pressure gauges were used to monitor the pressure drop between the two columns.

Water samples were collected from valves as the fluid exited the uranium and molybdenum polishing columns. The input/output molybdenum, uranium, sulfate, and chloride concentrations were measured using ICP-OES and tracked for both columns. Conductivity measurements were taken for each sample for the first three load cycles.

Injection water after undergoing filtration was piped into the columns 102, 104 using ¾″ PVC with a flow rate of 2.5 gal/min or 20 BV/hr. The flow rates, with respect to BV/hr, could not be matched for both test columns given that the uranium polishing column contained twice as much resin.

On average, the columns 102, 104 operated at a flow rate of 1.75 gal/min. The flow rates varied from 1.95 gal/min to 1.55 gal/min over the course of the test. The screen for the uranium polishing column failed and created a large pressure drop across the column by compressing resin within the ¾″ piping and valves. Resin was kept in the column by placing nylon screens on the down flow side of the valves prior to starting the test.

In one experiment, an attempt was made to relieve the pressure drop across the uranium polishing column by backwashing the column with injection water. Screens were put in place to keep the resin from escaping from the column.

The uranium and the molybdenum polishing columns were regenerated with EL3 brine prior to the start of testing. Approximately 15 gallons of fresh EL3 was used for each strip, except for the third strip on the molybdenum polishing column. This eluate contained Texas brine diluted with east injection water to ˜70,000 ppm CI. The Texas brine eluate did not contain any added bicarbonate/carbonate and the pH was raised to 10.85 with NaOH. High pH strips have been reported to remove polymerized molybdenum from within the matrix of the resin.

The columns 102, 104 were completely filled with injection water prior to the first EL3 strip and were rinsed with injection water after each strip. The resin regeneration was terminated once the uranium and molybdenum concentrations in the eluate post strip approached that of the baseline EL3 brine.

The primary eluate used to repeatedly strip the molybdenum polishing column was made by adding 9 gallons of regenerated EL3 brine and 6 gallons of Texas brine. The Texas brine addition increased the chloride concentration of the stripping fluid to 123,000 ppm. This addition was made to prolong the eluate's stripping power and thereby increasing the molybdate concentration. The decrease in bicarbonate concentration resulting from the Texas brine addition should only affect the stripping of uranium from the resin. Secondary column strips were made with the normal regenerated EL3 brine.

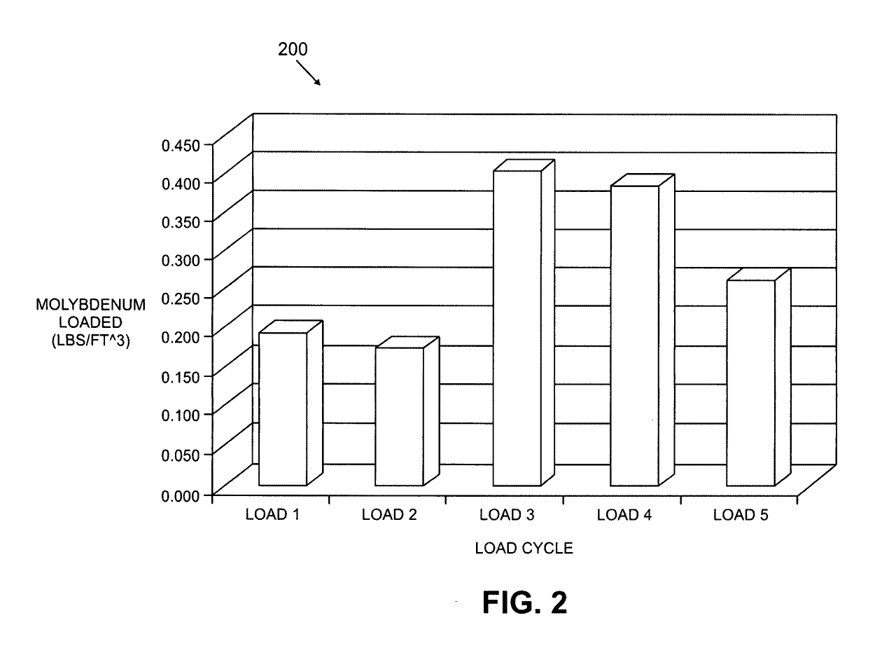

A chart 200 of the resin loading capacity for molybdenum was determined for five loading cycles, as shown in FIG. 2. The first two loading cycles were performed just prior to a new well field start up, i.e., the water quality was poor with respect to higher sulfate concentrations and lower molybdenum concentrations. These two cycles had a loading capacity of 0.18-0.19 lbs Mo/ft3 of resin. The final three loading cycles were performed after the new well field startup and significantly higher loading capacities were measured (0.26-0.41 lbs Mo/ft3 of resin).

It is understood that the anion composition of water may change during the course of the use of a well. In one experiment, water drawn from an “east” well was used. The molybdenum concentration increased in this well by approximately 40% and the sulfates and chloride concentrations decreased by 52 and 22% respectively after the new well field was started. In general, it was found that the water quality before and after the new well field start up provided a worst and best case scenario for testing the molybdenum loading capacity of the resin.

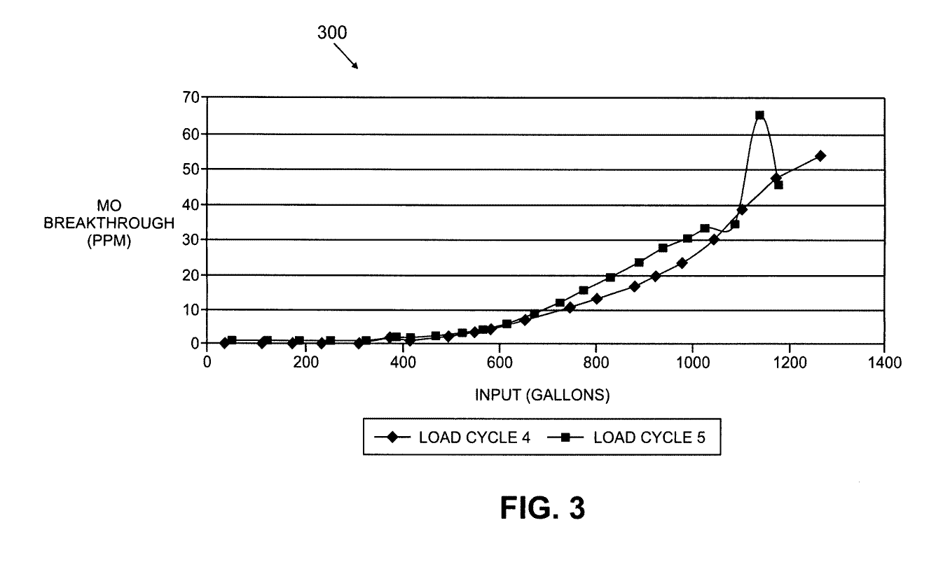

The sharp drop in the calculated loading capacity of load cycle 5 is likely due to a decrease in the molybdenum concentration exiting the uranium polishing column. The molybdenum concentration for load cycle 4 had a weighted average of 51.7 ppm compared to 40.8 ppm for load cycle 5, a 21% reduction. Additionally, the sulfate bleed from the uranium polishing column increased from a weighted average of 350 ppm in load cycle 4 to 465 ppm in load cycle 5, a 33% increase. Both load cycles 4 and 5 had similar molybdenum breakthrough concentrations except for an anomaly that occurred near the 1140 gallon mark of load cycle 5. Graph 300 illustrates this anomaly and is shown in FIG. 3. This anomaly played a very small role in the decrease of the molybdenum loading capacity. A column changeover may have occurred very close to the spike in molybdenum concentrations observed in the effluent from the uranium and molybdenum polishing columns. There was a 27% decrease in the amount of molybdenum loaded in cycle 5 compared to load cycle 4 by the 750 gallon mark for both tests. Note that the molybdenum breakthrough was almost identical up to this point, which further supports that the loading capacity decreased due to lower molybdenum input concentrations.

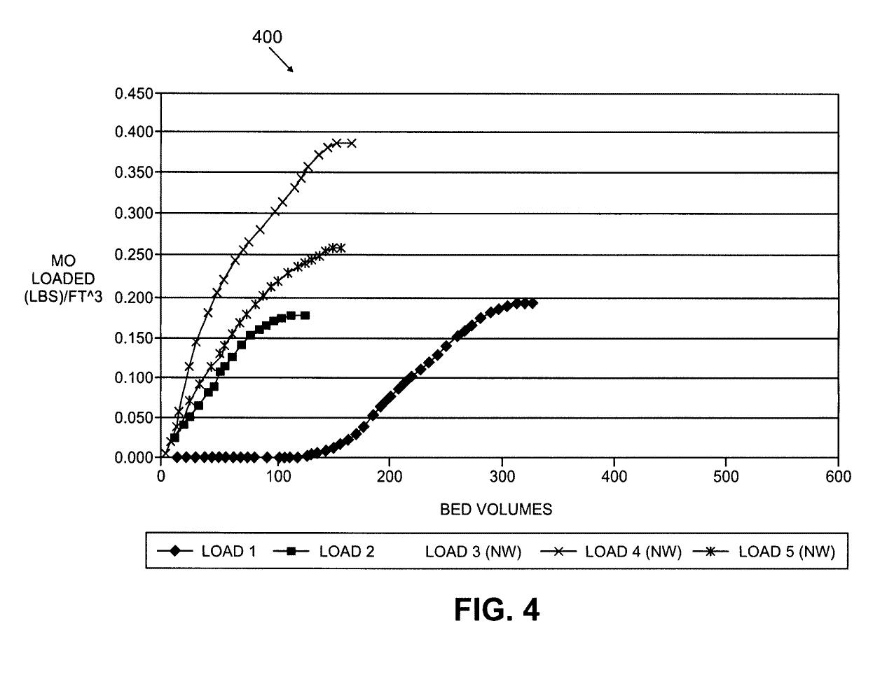

The molybdenum loading curves for all five load cycles are shown in graph 400 in FIG. 4. Load cycles 1 and 3 required significantly more fluid input to reach the molybdenum saturation point of the column. This was due to the unsaturated resin in the uranium polishing column at the start of the test (load cycle 1) and a re-equilibration period after the new well field was started (load cycle 3). Load cycle three would have taken longer to reach molybdenum saturation had the uranium polishing column not been partially saturated with the dirty east injection water during load cycles 1 and 2. In general, the first load cycle will require 3× the input volume to reach molybdenum saturation as subsequent load cycles.

The data indicates that the molybdenum polishing column will reach its maximum loading capacity for molybdenum during the initial load cycle. Subsequent load cycles will likely show a small decrease in molybdenum loading capacity as breakthrough of interfering anions (SO4⁻², UO₂—(CO₃)₂⁻²) increases from the uranium polishing column.

The loading characteristics for sulfates, uranium, and molybdenum were investigated to better understand the load-catch system of the uranium and molybdenum polishing columns using the east injection water. A secondary goal of was to determine the loading capacity of Dowex 2 IK® resin for uranium in the re-injection water given the construction of the south plant for this purpose.

Next to chlorides, sulfates are the most concentrated anionic species in the re-injection water. In general, sulfates increase steadily from a concentration of 300 to 600 ppm in the first 3 months after a new well field turn on. The resin's strong affinity for sulfates and their high concentration significantly influences the resin's loading capacity for uranium or molybdenum. The sulfate concentrations in the effluent were measured (ICP) as dissolved sulfur and converted to sulfate. Other dissolved sulfur species, such as bisulfide, would contribute to an over-estimation of the sulfate concentrations. However, possible interfering species are believed to be present in very low concentrations.

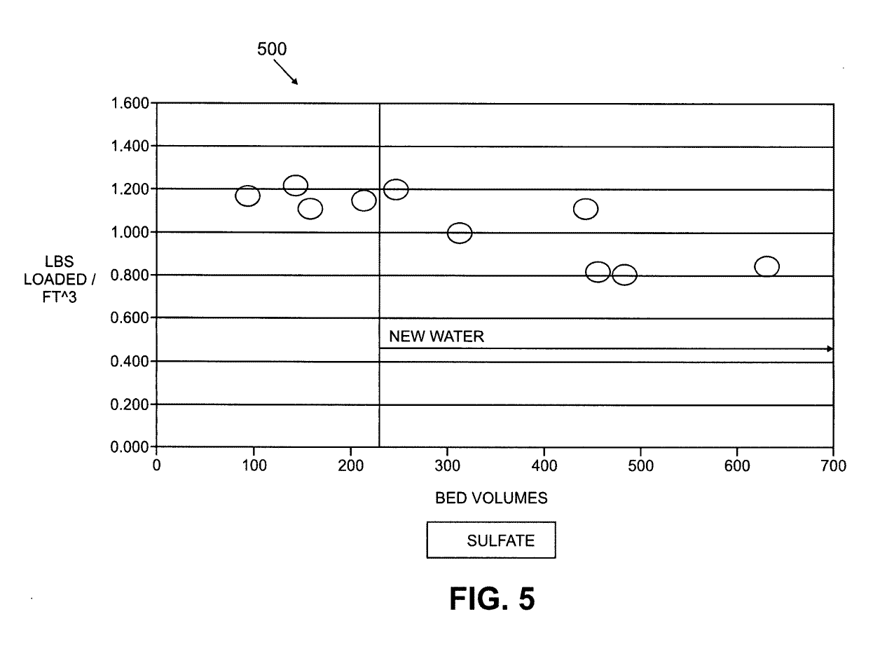

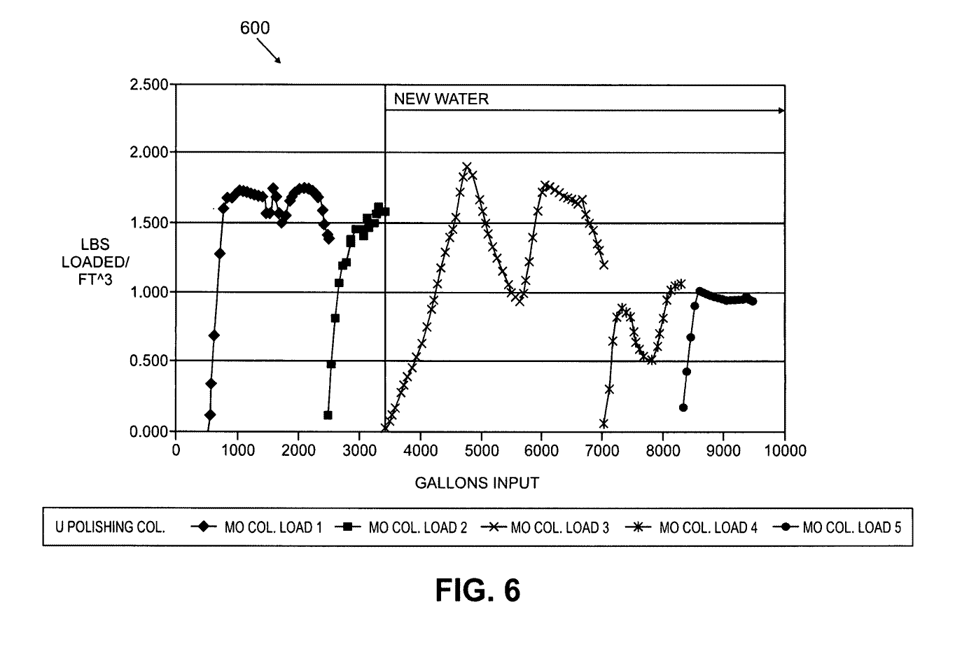

FIG. 5 is the sulfate loading curve for the uranium polishing column 102. The red circles reflect the timing of suspected column changeovers. The data is presented as a continuous loading sequence, but actually occurred in many small 300-500 gallon (20-33 bed volumes) increments. The circles represent samples collected during periods when column changeovers were believed to occur. A significant increase in chlorides, uranium, and conductivity as well as a sharp drop in sulfate and molybdenum concentrations were observed in the east injection water during these periods. The precipitous drops in sulfate loading, which coincide with the suspected column changeovers, are likely due to the temporary increase in chloride and uranium concentrations coupled with the decreased sulfate concentrations. Similar sulfate loading curves were observed for the molybdenum polishing column once it was saturated with sulfates, as shown in FIG. 6. FIG. 6 shows a comparison of the sulfate loading curves for the uranium and molybdenum polishing columns. Note that the sulfate loading between the uranium and molybdenum polishing columns mirror each other once the molybdenum polishing column reaches its sulfate loading capacity.

The maximum loading capacity of Dowex 21k® resin for sulfates is approximately 3.6 lbs S0₄⁻²/ft³ of resin, based on the exchange capacity of 1.2 equivalents/liter. FIGS. 5 and 6 indicate that 30-45% of the resins total exchange capacity is consumed by sulfates. Not all, but some of the dramatic peaks in the sulfate loading are explained by the input sulfate concentrations and column changeovers. For example, the sharp decrease observed on load cycle 3 (near 5,000 gallons) occurred at a column changeover where the sulfate input concentrations dropped from 317 ppm to 48 ppm.

The primary purpose of the uranium polishing column is to recover the last 5-10 ppm of uranium from injection water streams. Understanding its uranium breakthrough characteristics is important in producing a ferrimolybdate product that is free of uranium contamination. The loading capacity of DOWEX 21K XLT® for uranium in injection water streams at 10 ppm was previously estimated at 0.22 lbs U/ft3 of resin at 4 ppm uranium breakthrough. This was based on laboratory testing using the east extraction water (dirty water) and assumes a linear loading based on uranium concentration, given equal concentrations of competing ions.

This uranium loading test was not carried to completion. Uranium saturation, as defined by equal input/output concentrations, had not been reached when the molybdenum polishing column test was terminated. An attempt was made to carry-on the test using only the uranium polishing column, but the flow rate through the column had dropped below 1 gal/min. The poor flow rate and large pressure drop across the column was due to the previously noted screen failure.

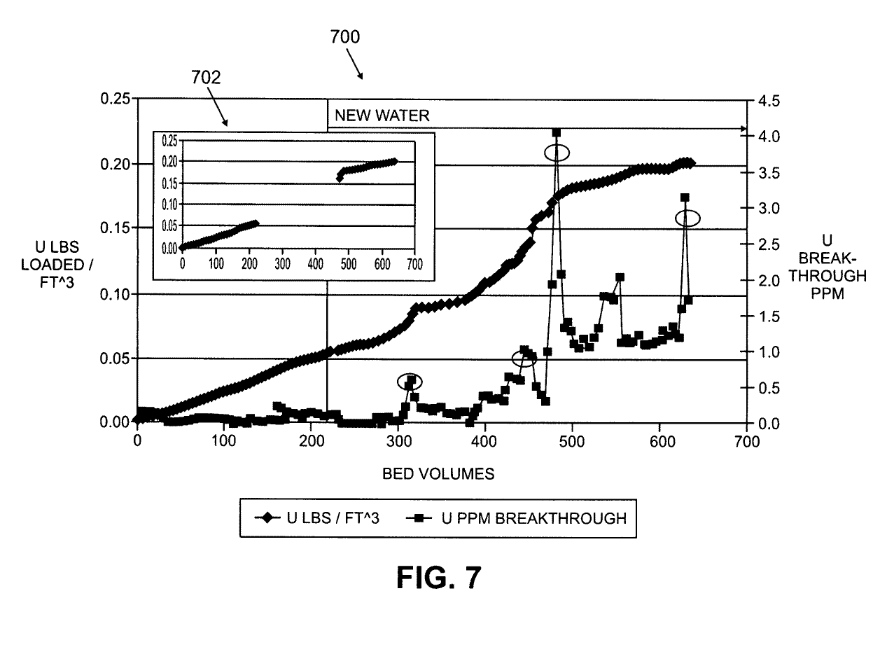

The uranium loading and breakthrough characteristics are shown in FIG. 7. FIG. 7 shows a graph 700 illustrating the uranium loading and breakthrough curves are shown for the uranium polishing column 102. A graph 702 shows the uranium loading curve as a function of the 5 molybdenum load cycles. The circles mark the timing of suspected column breaks of the primary up-flow columns in the plant. A loading capacity 0.20 lbs U/ft3 of resin was reached after 632 bed volumes using Dowex 21K resin. It is difficult to extrapolate a loading capacity for uranium given the stopping point of this test and the numerous variables that control the uranium concentration in the east injection water, e.g., resin stripping scheme, column changeovers, and rise and fall of the uranium concentration in the east extraction fluid. However, there does appear to be a decrease in the slope of the uranium loading towards the end of the test.

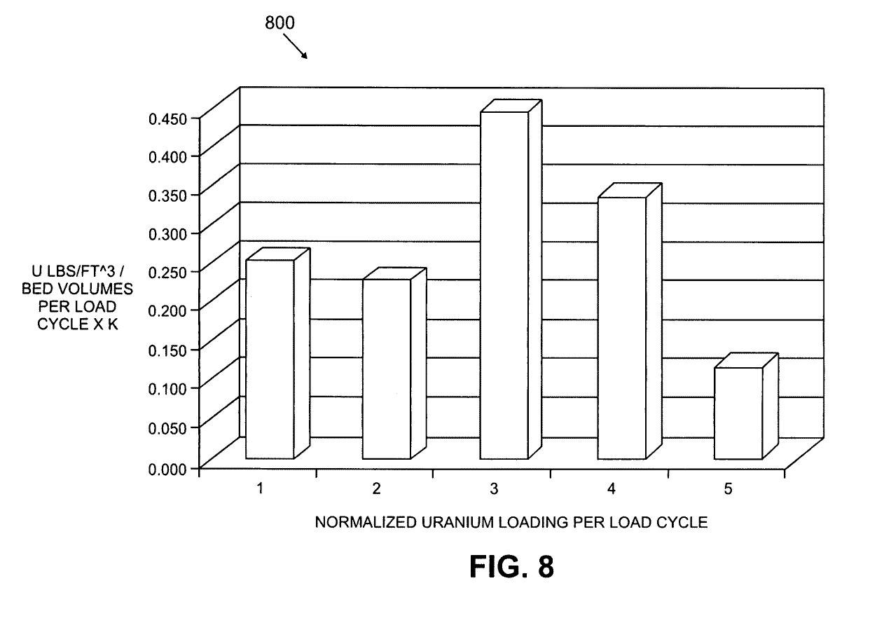

Normalizing the lbs U/ft3 of resin against bed volumes per load cycle shows the slow down in uranium loading as illustrated in chart 800 shown in FIG. 8. FIG. 8 shows a comparison of the lbs U/ft of resin loaded on the uranium polishing column during the five molybdenum loading cycles. The constant (K) was used to adjust the order of magnitude of the y-axis.

In this experiment, 0.01 lbs U/ft3 of resin were loaded over the final load cycle (75.6 bed volumes). A continuation in this trend over the next 350 bed volumes would create a total loading capacity for uranium of 0.25 lbs U/ft3 of resin. The uranium breakthrough at the ˜1,000 bed volume mark would be approaching the east injection water uranium concentrations (˜4 ppm at this time), indicating the saturation point of the column. Dowex 21K XLT, which will be used in the down flow columns, has a 14% increase in loading capacity compared to Dowex 21K. This would bring the anticipated loading capacity for uranium to 0.29 lbs U/ft3 of resin.

The uranium loading capacity of the resin may appear low, but the uranium concentration in the re-injection fluid is an order of magnitude lower than the extraction water. The loading capacity of 0.29 lbs U/ft3 of resin is in-line with the total uranium stripped on a per batch basis in the lower uranium ppm west plant. Based on this loading capacity, the down flow uranium polishing columns would reach saturation after 31 hours at an average uranium input concentration of 7.5 ppm and a flow rate of 1000 gal/min. This assumes that the uranium polishing columns are run until the average uranium input/output concentrations are equal.

The uranium polishing column 102 was effective at minimizing uranium contamination on the molybdenum polishing column. The uranium breakthrough concentrations remained below 1 ppm until a column break occurred around 450 bed volumes, as shown in FIG. 7. Three of the five load cycles for molybdenum were completed by 470 bed volumes. The 2:1 resin bed volume ratio between the uranium and molybdenum polishing columns provides a reasonable balance between minimizing uranium contamination and maximizing the exposure time to peak molybdenum breakthrough concentrations.

The sharp spikes in uranium concentration match up exactly with column changeovers. After recovering from the last column changeover (630 BV), the uranium breakthrough concentration would be near 1.3-1.5 ppm. The average uranium concentration in the east injection water, post new well field turn on, was near 7 ppm in the first 30 days and dropped to 4 ppm by the end of the test due to changes in the elution scheme.

At first glance it appears beneficial to bypass the molybdenum polishing column for a short period after a column break to minimize uranium contamination. However, the column breaks also create periods of high molybdenum breakthrough from the uranium polishing column.

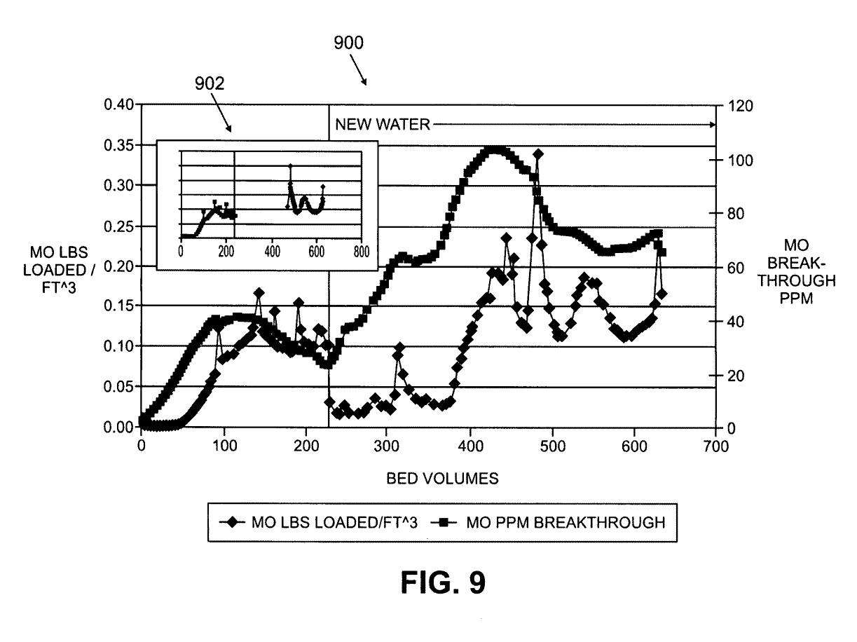

The molybdenum loading and breakthrough concentrations are shown in FIG. 9 for the U-polishing column. The molybdenum loading and breakthrough concentrations are shown in graph 900 for the uranium polishing column. A graph 902 shows the molybdenum breakthrough concentrations as a function of the 5 load cycles. During the initial load cycle, with the dirtier east injection water, the maximum molybdenum loading capacity was reached in 115 bed volumes. The maximum molybdenum breakthrough concentration was reached in approximately 150 bed volumes.

The maximum molybdenum loading capacity greatly improved after the new well field startup, reaching a peak near 0.35 lbs Mo/ft3 of resin. The amount of bed volumes required to reach this maximum with clean water is skewed because of the previous two loading cycles, but is estimated at 329 bed volumes. The molybdenum breakthrough concentration largely trended with the molybdenum input concentrations once the uranium polishing column reached molybdenum saturation. The two exceptions to this are the molybdenum spikes created after the column changeovers and the breakthrough concentrations during load cycle four, which were slightly higher than the input concentrations. The later observation helps explain why there was little fall off in the molybdenum loading capacity between cycles 3 and 4.

Previous testing has shown that our normal eluate was effective in removing molybdenum from Dowex 21K resin and that bicarbonate is not needed. Complete elimination of bicarbonate from the eluate is not recommended because some uranium contamination is expected. All 5 columns were eluted for at least 10 bed volumes. With respect to stripping efficiency, the data from the first four column elutions indicate that 3 bed volumes of eluate re-circulation are required to reach the maximum molybdenum recovery.

A summary of all five column elutions is shown in Table 1 below:

TABLE 1

| | Total Vol. | | | | Cl | Cl |
|---|---|---|---|---|---|---|
| | Circulated | U | Mo | SO₄ | (ICP) | (titration) |
| Start | primary strip | 65 | 5 | 1665 | 100396 | 123000 |
| 1st | 202 gallons | 78 | 1478 | 10633 | 81997 | 104500 |
| 2nd | 80 gallons | 89 | 2624 | 22353 | 70857 | 83000 |
| 3rd | 90 gallons | 139 | 4622 | 25524 | 47686 | 55000 |
| 4th | 159 gallons | 264 | 6283 | 31004 | 35165 | 40000 |
| 5th | 165 gallons (nitric) | 325 | 6287 | 33862 | 25380 | 37000* |
| 5th | 165 gallons (H₂O) | 311 | 6726 | 36810 | 28002 | N/A |

A maximum molybdenum concentration of 6,726 ppm was reached after the 4th elution cycle. Surprisingly, no molybdenum was stripped from the column on the 51 h elution cycle. All of the ICP data points in the table were generated from diluted samples in a matrix of 2% (v/v) nitric acid. It was determined during the course of this testing that molybdate is not stable in dilute nitric acid, and our standard dilution matrices resulted in an 8-10% decrease in measured molybdenum concentrations. The final eluate concentration was tested twice, with and without nitric acid, and revealed a 9.34% discrepancy in the molybdenum concentrations.

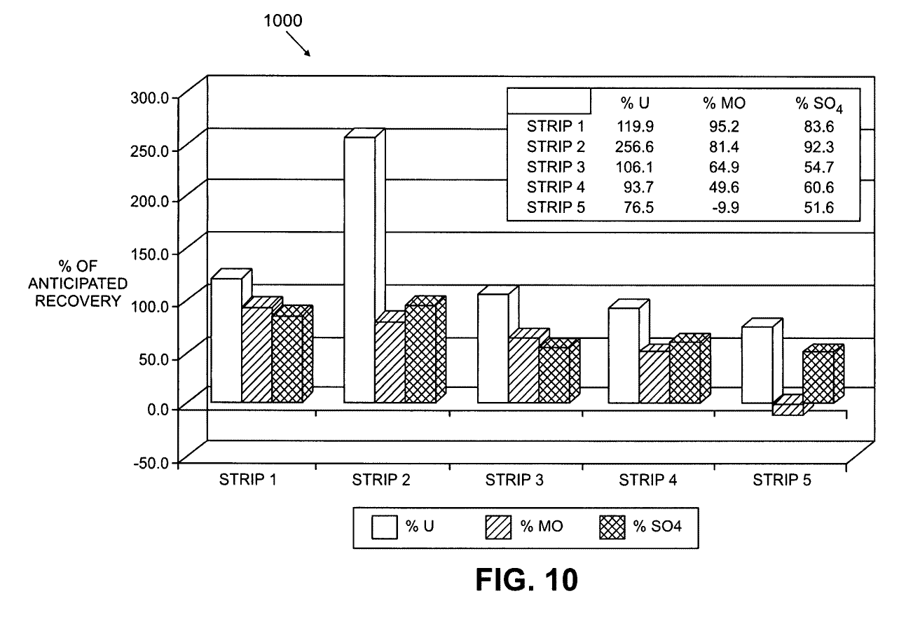

Suspect color development interference as ICP shows more reasonable drop in chloride concentration, and at this concentration the ICP is now in the linear range for chlorides at a 100× dilution. The efficiency of each elution was determined for uranium, molybdenum, and sulfates based on the calculated loading of each species per load cycle and the measured concentrations recovered in the eluate as shown in FIG. 10. FIG. 10 shows a graph 1000 illustrating a comparison of the stripping efficiency of the eluate through the five load/strip cycles.

The high uranium recoveries are likely due to measurement errors in samples where the uranium concentrations were near the detection limit of the instrument. The errors represent a very small amount of uranium. For example, the difference between 250% and 100% uranium recovery in strip 2 was a measurement error of +45 ppb.

A 15% decrease in the molybdenum stripping efficiency was measured after each strip cycle through strip 4. The fifth strip cycle did not remove any molybdenum, instead the molybdenum concentration in the eluate decreased by 200 ppm. This was unexpected as the chloride concentration in the eluate was approximately 40,000 ppm, which should be sufficient to continue stripping some molybdenum. It appears that equilibrium was reached between the concentration of molybdenum in the eluate and the molybdenum loaded on the resin. The ratio of the molybdenum concentration in the eluate to the grams Mo/ft3 of resin is 55:1. Various ratios could be used to express this relationship, but the concentration (ppm) of molybdenum in the eluate versus the grams Mo/ft of resin has some practicality to operations. Knowledge of the loading capacity of the resin, given the current water chemistry, should be a strong indicator for determining when the eluate stripping will fail completely.

Quantitative secondary strips were performed after the first, fourth and fifth primary strips. The recovery percentages for uranium, molybdenum and sulfate are shown in Table 2. These were used to double check the calculated molybdenum mass balance between the load and strip cycles and ensure the resin was fully regenerated between load cycles.

TABLE 2

| | % U | % Mo | % SO₄ |
|---|---|---|---|
| Secondary Strip (gal) | Recovered | Recovered | Recovered |
| After 1st Primary Strip | 119.88 | 105.51 | 84.03 |
| After 4th Primary Strip | 104.43 | 96.34 | 95.46 |
| After 5th Primary Strip | 105.55 | 91.79 | 104.53 |

Table 2. The combined mass balance of the primary and secondary strips are shown for the 1st, 4th, and 5th load/strip cycles, Secondary strips were performed for the 2nd and 3rd load/strip cycles to regenerate the resin but no information was collected.

Molybdenum was precipitated from the eluate by dropping the eluate pH to 2.33 with sulfuric acid and adding 2 L of concentrated ferric chloride solution at a pH of 0.91. The ferric chloride solution was made by adding 930.891 g of ferric chloride hexahydrate to 2 L of distilled water pH adjusted to 2.10 with hydrochloric acid. The final pH of the ferric chloride solution was 0.91. Concentrated sodium hydroxide was used to maintain the eluate pH near 2.30 as the more acidic ferric chloride solution was added. The pH of the water used to dissolve the ferric chloride is important and should be adjusted to near 2.0 before dissolving the ferric chloride to prevent ferric hydroxide from forming (Appendix A.1). Note that the volume of ferric chloride solution represents 3.5% of the eluate volume.

In one experiment, a total of 192.322 g of iron was added to 56.6 L of eluate containing 384.643 g of molybdenum. This is equivalent to a 1.0:2.0 iron to molybdenum weight ratio or a 3.4:4.0 iron to molybdenum mole ratio. The anticipated product was identified by XRD as Fe2Mo3-40i2.i5˜H20. The iron to molybdenum weight ratio in the product is approximately 1.0:3.0 as precipitated at a pH between 2.0-2.4.

Previous tests had shown that only 80% of the molybdenum could be precipitated at a 1.0:2.0 iron to molybdenum weight ratio in the pH range from 2.0-2.4. It is anticipated that the ferrimolybdate product precipitated in this pH range would contain the highest molybdenum to iron ratio, but potentially lower recovery rates. Additional, precipitation tests performed at a pH of 3 with extra dissolved iron added did not significantly improve the molybdenum recovery beyond 80%.

The first precipitation test performed as expected with approximately 81-82% of the molybdenum recovered as a precipitant. Table 8 summarizes the first precipitation step by comparing the before and after molybdenum concentrations in the eluate with respect to the dilution matrices used to run the samples on the ICP. The iron to molybdenum weight ratio in the product was 1,0:2.7, compared to the formula ratio of 1.0:3.0.

The before and after uranium, molybdenum, and sulfate concentrations are shown in Table 3. Co-precipitation of uranium with molybdenum appears to be minimal if any. The increase in sulfate concentration is due to the sulfuric acid used to drop the eluate pH to 2.3. Table 3 shows the concentration of anionic species in solution before and after the precipitation reaction at a pH of 2.3. Data is given for dilutions made with nitric acid and water.

TABLE 3

| Dilution Matrix | U | Mo | SO₄ | Cl | Fe |
|---|---|---|---|---|---|
| Baseline HNO₃ | 325 | 6287 | 33862 | 25380 | 3288 |
| After - HNO₃ | 320 | 1207 | 43922 | n/a | 1302 |
| Baseline H₂O | 311 | 6726 | 36810 | 28002 | 3288 |
| After - H₂O | 344 | 1223 | 48024 | n/a | 1301 |

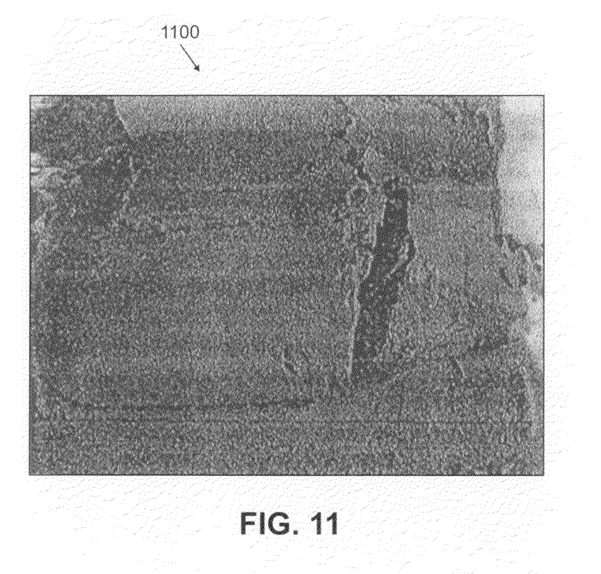

The precipitant was gravity filtered through a 1 micron Hatfield filter bag. After filtration, the goal was to rinse the precipitant with clean water to flush out any residual uranium contamination from the eluate. This proved to be an ill-conceived idea as the precipitant retained nearly 80% water by weight after the gravity filtration procedure, and pressure could not be applied to the bag to speed up the rinse time without causing some precipitant to bleed through the bag. The appearance of the precipitant in an opened bag filter is shown in picture 1100 shown in FIG. 11. FIG. 11 shows the appearance of the ferrimolybdate precipitant as generated (no drying) at a pH of 2.3.

Eventually the precipitant was placed into a 5 gallon carboy to try and remove the uranium contamination from the eluate through a series of dilutions with distilled water. This procedure proved partially effective. It is suspected that the precipitant remained clumped together in a congealed state and was not completely suspended in solution after agitation. The precipitant was then re-filtered and partially dried in an oven at 65° C. The final product contained approximately 20% water by weight and close to 1.3 mg U/kg of completely dried product. Approximately 0.92 lbs of the dried ferrimolybdate product was sent to Amlon Resource Group for evaluation and possible pricing estimates.

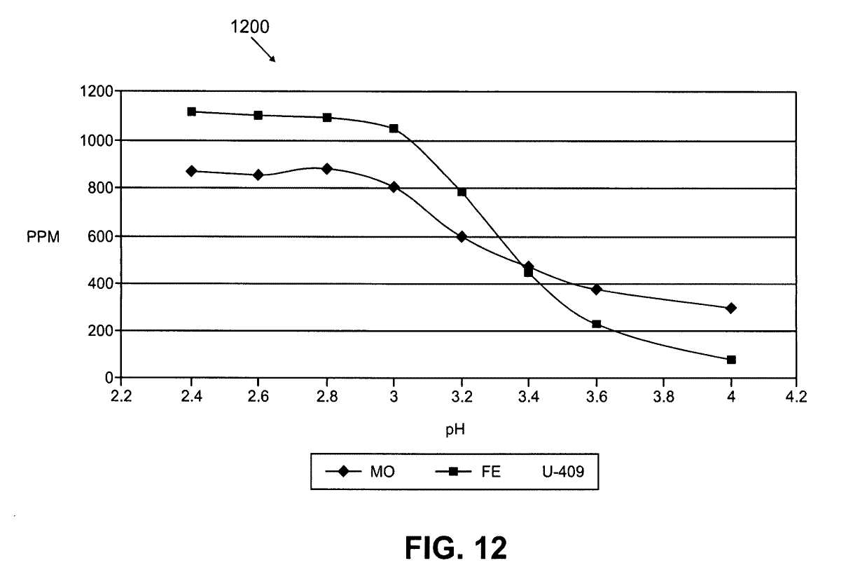

A Second Precipitation Test was preformed at pH 3.4. An attempt was made to recover the residual 1,200 ppm of molybdenum from the eluate. The referenced paper in footnote 3 indicated that 99% of the molybdenum in their tests was recovered at a pH of 3.4-3.6. To test this claim with our eluate, a series of small tests in beakers were performed at pH's 2.6, 2.8,3.0, 3.2,3.4, 3.6, and 4.0. A summary of the test results with respect to residual molybdenum, iron, and uranium concentrations is shown in FIG. 12. FIG. 12 shows beaker test results 1200 including the effect of pH on the recovery of residual molybdenum, iron, and uranium after the first precipitation reaction at pH 2.3.

The initial molybdenum concentration in these tests was below the 1,200 ppm for two reasons. First, additional precipitation of a ferrimolybdate product occurred in the eluate reservoir between the initial filtration step and the time this test was performed, and secondly there was some dilution of this fluid with rinse water from the initial filtration step. It is clear that significant drops in the molybdenum and iron concentrations do not occur until a pH of 3.2 is reached. The molybdenum recovery rate at pH 3.4 was 93.1% based upon the initial molybdenum concentration of 6,726 ppm. At pH 3.6 the recovery rate was 94.4%. The weight ratio of molybdenum to iron that dropped out of solution at pH 3.4 and 3.6 was nearly equal. Note that the uranium concentrations are stable throughout the pH adjustments.

A secondary precipitation test was performed at a pH of 3.4 by adding concentrated sodium hydroxide to increase the eluate pH. The molybdenum and iron recovery rates at a pH of 3.4 were 95.5% and 97.5% respectively.

The residual molybdenum concentration (−245 ppm) at a pH of 3.4 is significantly lower than that obtained in the beaker testing (466 ppm). This may be due to length of time the solution was allowed to sit before collecting a sample and/or the related to the volumes of fluid used and mass of precipitants formed.

The product formed, at a pH of 3.4 was similar to in consistency (gelatinous) to that formed at a pH of 2.3. It did appear to settle out of solution faster and filter easier through a 1 micron Hatfield filter bag than the product formed at a pH of 2.3. The calculated weight ratio of iron to molybdenum in this product is 1.0:2.2. This product was a dark rust color compared to the light yellow color of the pH 2.3 product. The estimated molybdenum weight percent of the mixed precipitant products is 47% in a fully dried state. Both precipitant products were sent off to E. Haile and Associates for a metals analysis to include molybdenum, silicon, iron, sulfur, calcium, sodium, vanadium, phosphorus, and potassium. Uranium could not be analyzed for; however, Xenco laboratories felt they could accurately determine the uranium concentration in the precipitants.

Small scale precipitation tests were performed to define the time needed to reach the endpoint of the precipitation reaction. These tests were performed at a pH of 1.8 and 2.5 and should be considered more qualitative than quantitative when compared to the larger pilot plant investigation. The results suggest that the higher pH precipitation reactions occur faster and/or the products are less soluble and generate a higher molybdenum recovery percentage. The molybdenum recovery rates at a pH of 2.5 did not improve beyond 81% after 500+hours.

Tests were also run with eluate that contained approximately 5,000 ppm molybdenum and 1,000 ppm uranium. A two step precipitation reaction was run to selectively precipitate out the uranium and then precipitate out molybdenum. This process was effective at selectively removing the uranium from the eluate; however, when compared to a typical plant slurry it required significantly more hydrogen peroxide and longer reaction times to achieve a 95% reduction in the uranium concentration. Therefore, it is not as cost effective with respect to time and money. Molybdenum contamination in this yellow cake might be slightly higher than normal too.

Strong base anion exchange resins, such as Dowex 21K®, do not have a high affinity for molybdenum in the form of molybdate (M0O4)-2 at a near neutral pH. Other resins that have a higher affinity for molybdate, such as chelating resins, would acidify the re-injection water returning to the well field. To date, all reports that involve molybdenum recovery using ion-exchange technology do so at an acidic pH (−2.0) where strong and weak base anion exchange resins work better. The lack of an efficient resin for molybdate removal at near neutral pH is due to a lack of industry supporting this application.

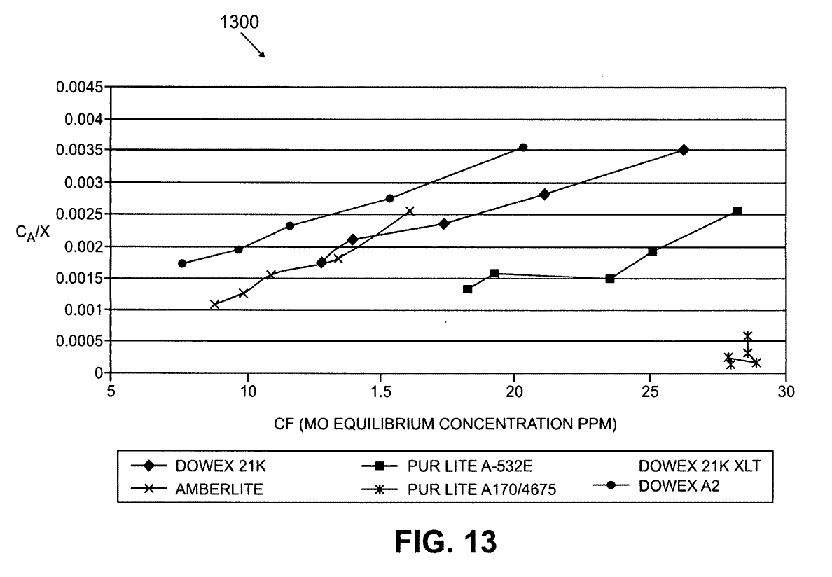

Adsorption isotherm plots were generated for several resins to investigate if they have a higher affinity for molybdate in comparison to Dowex 2IK®. The daily composite east injection water samples were used for the tests. The results of these tests are shown below in FIG. 13. FIG. 13 shows the results of the adsorption isotherm data are shown as a Freundlich plot 1300.

An adsorption (Freundlich) isotherm plots the capacity of the media for the component of interest (CA/X) versus the equilibrium concentration (Cf). After careful review, it was a mistake not to test each resin with identical solutions. The interpretation of the data is difficult because the measured capacity of the resin (Ca/X) is related to the initial concentration of molybdenum in solution, which was not constant throughout the testing.

The volume of resin needed to treat a given volume of fluid for a specific anion to a final solution concentration would be determined from the graph. For example, 200 ft3 of Dowex A2 resin could treat 82,563 gallons of east injection fluid at 29 ppm Mo to an equilibrium concentration of 7.5 ppm. Applying a regression line to this data set to extrapolate smaller Cp values indicates that we would need 473 ft3 or resin to reach an equilibrium concentration of 2 ppm in 82,563 gallons of east injection fluid at 29 ppm.

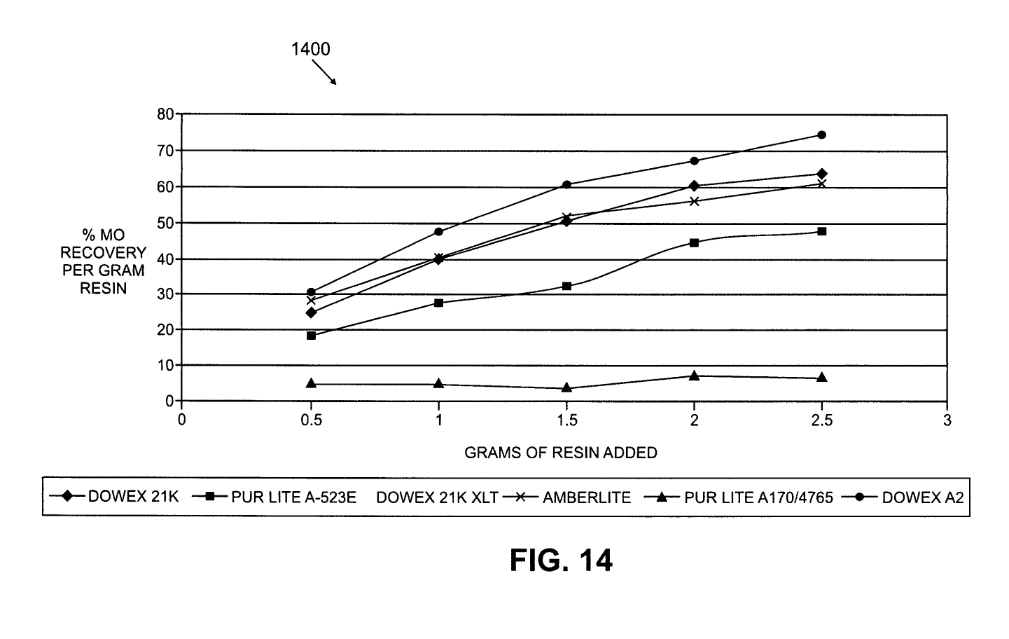

Another way to interpret the data is to look at the percentage of molybdenum recovered versus the weight of resin added to the solution. FIG. 14 shows the percent molybdenum recovery is shown versus the grams of resin added to the composite east injection water samples.

This normalized the data against the starting head grade concentrations for each resin. The top two performing resins were Dowex A2® (1) and Dowex 21K XLT®. These resins are both strong base anionic exchange resins with identical size distributions, but they have different functional groups and different recommended regenerative solutions. Dowex 2 IK XLT® remains the primary candidate for molybdenum recovery given our familiarity with the resin.

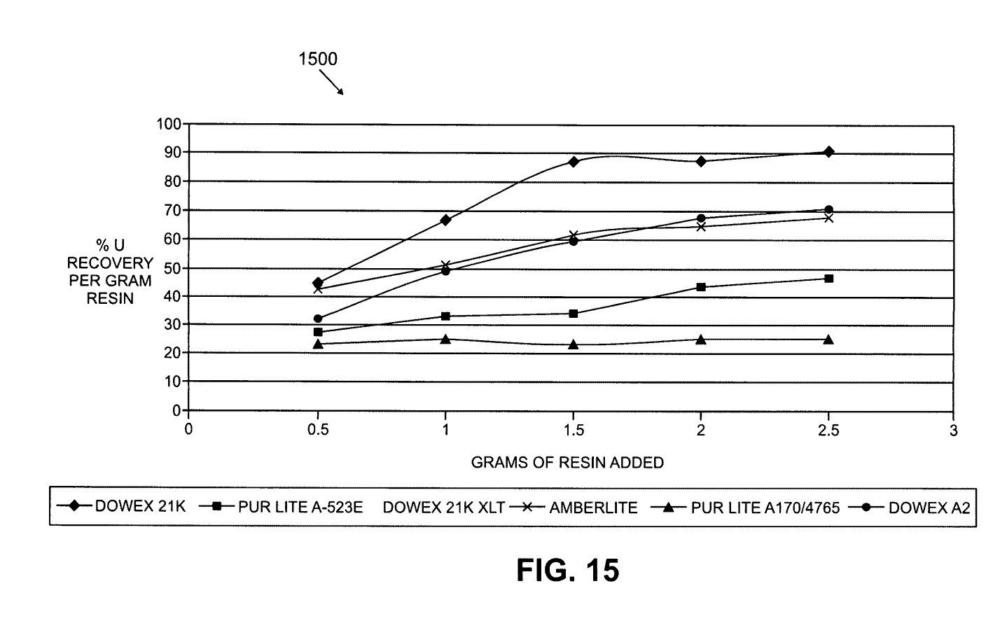

The uranium recoveries were also tracked during the resin study and revealed a surprising result The Dowex A2® resin appeared to be the strongest candidate for uranium recovery in the east injection fluid, as shown in FIG. 15. FIG. 15 illustrates a graph 1500 of the percent uranium recovery is shown versus the grams of resin added to the composite east injection water samples.

This test was repeated using only the Dowex 2 IK XLT® and Dowex (Marathon) A2® resins in identical east injection water samples. Dowex 21K XLT® was the best performing resin in the second test; although, both resins performance was very close for the molybdenum recoveries.

In general, the strong base type II anion resins (Marathon A2®) do not bind as tightly to a specific anion as the strong base type I resins (Dowex 21K XLT®). The type II resins are eluted easier though and this may offer an advantage with respect to molybdenum. Molybdenum is normally considered a fouling agent for Dowex 21K® and 21K XLT®. It is understood that that a 0.5% caustic strip is effective at removing molybdenum from resin (Amberlite XE-123®). The fouling issue, coupled with both resin's similar performance in the isotherm studies and that the recommended regeneration solution for Marathon A2® resin is a 2-5% caustic solution, make it a strong resin candidate for molybdenum recovery.

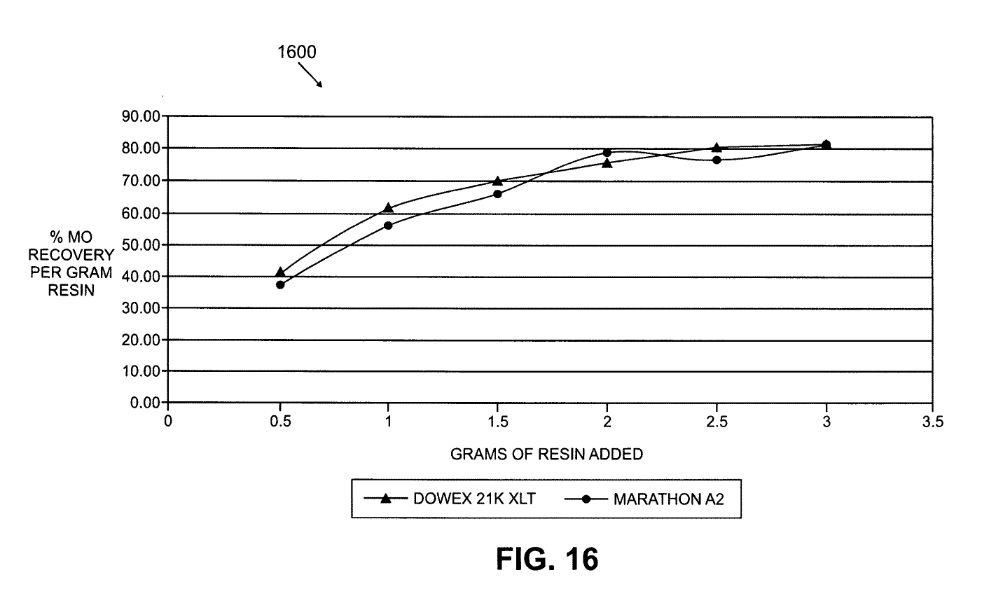

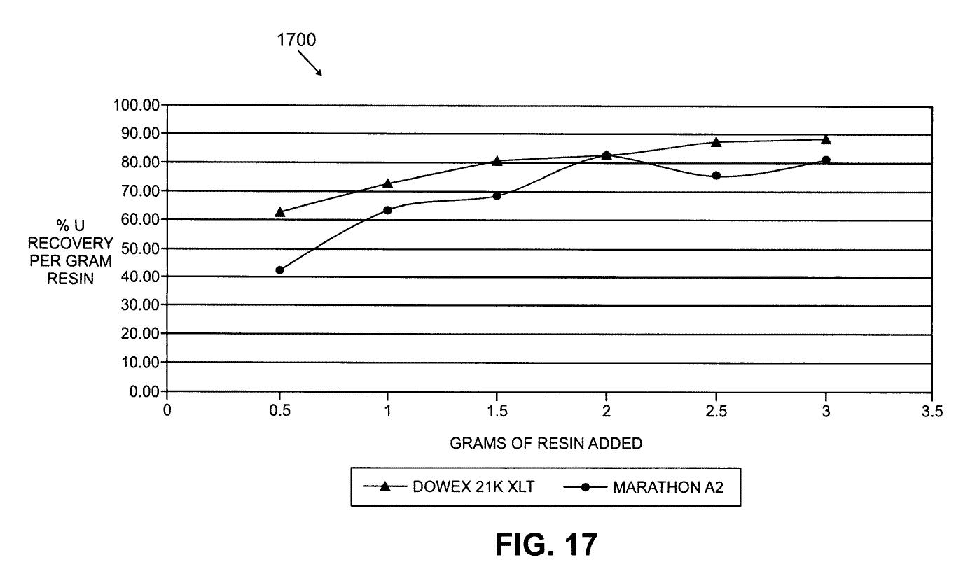

FIG. 16 shows a graph 1600 the percent molybdenum recovery is shown versus the grams of resin added to the injection water samples (not a composite sample). In FIG. 17, the percent uranium recovery is shown versus the grams of resin added to the injection water samples (not a composite sample).

In some embodiments it is contemplated that the uranium polishing columns would run until the uranium input/output concentrations are nearly identical, i.e., the column has reached its maximum uranium saturation given the input concentration. Uranium would be lost doing this, but it would maximize the uranium loading on the resin, increase the uranium concentration in the slurry eluate, and improve upon chemical costs (brine, hydrogen peroxide) versus pounds of uranium precipitated. However, the uranium polishing columns will see a steady increase in uranium input concentration as the up flow load/catch system becomes saturated with uranium. The only predefined saturation endpoint to look at is the average uranium concentrations measured from daily injection composite samples. We could consider the uranium polishing columns saturated when the breakthrough concentration meets or exceeds the average uranium concentration from the daily injection composite samples.

It is contemplated that the time required to reach saturation will vary depending on how the up flow columns are run, the water quality, and how the saturation point is defined. We can estimate that with new water it would take 400 ft³ of resin 48 hours to saturate with a constant input concentration of 5 ppm uranium at 1,000 gal/min flow and a loading capacity of 0.30 lbs U/ft3. This assumes that all of the uranium is collected on the resin. This test data indicates that ˜1,000 bed volumes are needed to reach a uranium breakthrough concentration of −4-5 ppm. This would require 50 hours of flow at 1,000 gallons/min to reach −0.30 lbs U/ft3 and includes uranium loss due to breakthrough. The estimated time required to saturate the uranium polishing columns will be reduced in the two plants that have poorer water quality (18-24 hours).

It is understood that, in some embodiments, in order to achieve the maximum molybdenum loading the columns may be run until the input/output concentrations are equal. The uranium primary and polishing columns will saturate with molybdenum quickly when compared to uranium, but the 1,600 ft3 of resin contained in these three columns still creates a large lag time before the molybdenum reaches the molybdenum polishing columns. It is estimated that significant molybdenum breakthrough (>20 ppm) will occur from the primary uranium column almost immediately since it was the catch column on the previous cycle. The primary catch column may take another 100-150 bed volumes (3.5-5.5 hrs) to release a constant, high concentration of molybdenum to the uranium polishing column. To reach significant molybdenum breakthrough from the primary catch column we have consumed −4.5 hours, depending on water quality, of a typical 9-12 hour primary column load cycle.

At this point the 400 ft3 uranium polishing column will need to be saturated with molybdenum, which may take another 2-4 hours at 1,000 gal/min. Note that a fresh uranium polishing column receiving a constant molybdenum input would take 100-150 bed volumes to saturate or 5-7 hours at 1,000 gal/min. On average, it will take −7.5 hours to push the molybdenum through all three columns and saturate the smaller molybdenum polishing column. This time frame makes some sense as 7.5 hours of flow at 1,000 gal/min is equal to 300 bed volumes of input for the molybdenum polishing column, and the first saturation cycle was previously estimated at 329 bed volumes based on the test data with clean water.

The molybdenum polishing columns reach their saturation point close to the uranium polishing columns, with respect to molybdenum, because they only contain 50% of the resin volume or 200 ft3. At this point the molybdenum polishing column should be stripped. The stripping processes will likely consume the time left on the primary uranium load cycle. The rotation of the load/catch columns will cause a decrease in the molybdenum breakthrough to the uranium and molybdenum polishing columns. This effect will be partially diminished by the large molybdenum spike that is often observed immediately after a column changeover, and a re-equilibration between the resin and the water that now contains little molybdenum, i.e., the uranium polishing column will still continue to bleed molybdenum to the molybdenum polishing column.

The goal now is to complete the next three load/strip cycles for the molybdenum polishing column before the uranium polishing column has reached its saturation point for uranium. Each load cycle will now require between 150-170 bed volumes of input or 2.5-3.7 hours (7.5-11.1 hrs).

It is understood that the dissolved iron needs to be in the ferric state to precipitate a product with the highest molybdenum content. Unfortunately, the pH range (2.0-2.4) where this is possible only produces an 80-82% recovery of the molybdenum. Increasing the pH to 3.4 will bring the recovery rates to ˜95%, but decrease the weight % of molybdenum in the product and increase the uranium contamination as a co-precipitant. At this time, it is recommended that the iron to molybdenum weight ratio match the stiocbiometric iron to molybdenum weight ratios based on the products generated at a pH of 2.3 and 3.4. This would be equivalent to a 1.0:3.0 iron to molybdenum weight ratio at pH of 2.3 (80% recovery) and a 1,2:1 iron to molybdenum weight ratio at a pH of 3.4 (˜20% recovery). For example, in this study we had 384.643 g of molybdenum and would expect to precipitate 80% of that using an iron to molybdenum weight ratio of 1.0:3.0. This would require 102.57 g of iron. We would expect to precipitate the final 20% using an iron to molybdenum weight ratio of 1.2:1.0. This would require 92.31 grams of iron and bring the total iron weight required to 194,88 grams. Originally, 192.322 g of iron based on precipitating 100% of the molybdenum at a 1.0:2.0 iron to molybdenum weight ratio. The test data suggests that this ratio could be increased to at least 1.0:2.2 and still achieve a recovery rate near 95%.

The pH of the slurry eluate will need to be kept at 2.3 until 80% of the molybdenum has dropped out of solution. Concentrated caustic can slowly be metered in to do this as the more acidic ferric chloride solution is added. The pH of the slurry eluate can be raised to 3.4 to precipitate the final 20% of the molybdenum. During this step any un-reacted iron will precipitate out as ferric hydroxide.

It is further understood that almost all of the uranium contamination comes from dissolved uranium in the eluate that is “trapped” in the gelatinous precipitation product. This contamination could be removed after filtering the product in a press by performing a series of clean water flushes and press cycles. Another option is to allow the precipitant to settle, pump out the majority of the eluate down to the solids level, flood and agitate the precipitation tank with clean water, and then repeat the process until the uranium contamination has been virtually eliminated. This is more of a dilution process, but was effective in the lab in reducing the uranium contamination when performed before filtering the product. A third option is to selectively precipitate out the uranium from the molybdenum eluate. This should only be considered if the uranium concentration in the eluate exceeds 1,000 ppm.

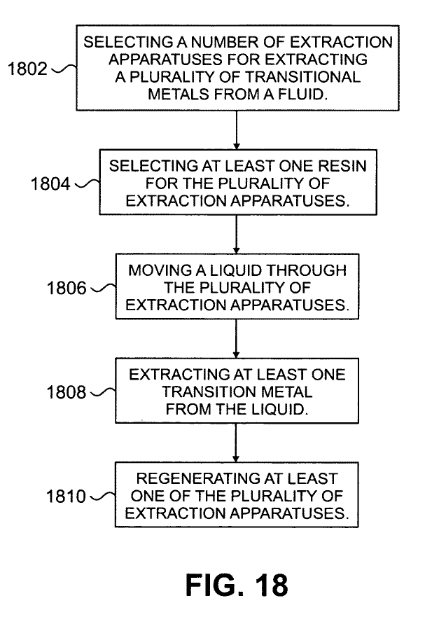

FIG. 18 is a flowchart illustrating one method of extracting a material through the disclosed systems and methods. In block 1802, a number of extraction apparatuses are selected for extracting a plurality of transitional metals from a fluid. The selection of the extraction apparatus may depend upon the type of material to be extracted from the fluid. For instance, in extraction Uranium or a specific transition metal, a cylinder may be used of a specific size and length. In block 1804 at least one resin is selected for use in each of the plurality of extraction apparatuses. The same selected resin may be used in each of the selected extraction apparatuses, or different resins may be used depending on the materials to be extracted from the fluid. It is expressly understood that specific resins may be chosen to extract specific elements from the fluid. In addition, the resins may be held in place through the use of grates, filters, adhesive, or any other apparatus or method known to one skilled in the art. In block 1806, a fluid comprising the material to be extracted is moved through the extraction apparatuses. It is understood that this fluid may comprise a plurality of different elements to be extracted. In block 1808, at least one at least one transition metal is extracted from the liquid. In block 1810, the at least one of the plurality of extraction apparatuses is regenerated.

A number of unique and novel elements, including those yielded through experimental data are discussed herein. These results include that the loading capacity of the resin comprising a strong base anion with a quaternary amine functional group for molybdenum may be significantly influenced by competing anions and molybdenum concentration in the lixiviant. In “dirty” water the expected loading capacities are approximately 0.18-0.26 lbs Mo/ft3 of resin. In “clean” water the expected loading capacities are approximately 0.26 to 0.41 lbs Mo/ft3 of resin. Increasing the exchange capacity of the resin comprising a strong base anion with a quaternary amine functional group by approximately 14% increase bring the expected loading capacities to approximately 0.21 to 0.30 lbs Mo/ft3 in “dirty” water and approximately 0.30 to 0.48 lbs Mo/ft3 in “clean” water. In addition, it was determined that an equilibrium point between transition metal concentration, such as molybdenum concentration, in the eluate and the molybdenum mass loaded on the resin, at which point the stripping efficiency drops to zero. For example, the equilibrium point, expressed as a ratio of molybdenum ppm in the eluate to grams molybdenum per ft̂3 of resin is approximately 55:1.

The equilibrium ratio and loading capacity of the resin in “dirty” and “clean” water defines the maximum obtainable molybdenum eluate concentrations was between 3,900 to 9,000 ppm. In addition, the stripping efficiency of the primary eluate for molybdenum will decrease by approximately 15% after each elution. It is understood that this decrease may be more severe if the down flow columns cannot be fully drained.

A 2:1 ratio in resin bed volume between the uranium and molybdenum polishing columns was effective in minimizing uranium contamination in the molybdenum eluate. In addition, co-precipitation of uranium in the precipitation process for molybdenum is minimal. It was found that the worst case scenario in this data set shows a uranium loss of 0.0474% or 474 mg/kg of dried product. The dilution factor of adding in the ferric chloride solution to the eluate should have decreased the uranium concentration by 3.5%, which more than accounts for the measured uranium loss.

Experimental data further disclosed that precipitation steps outlined in this investigation recovered 93% of the molybdenum from the eluate while consuming 86% of the dissolved iron. This is a stoichiometric reaction based on the anticipated products formed at a pH of 2.3 and 3.4. The products formed at these pH values are tentatively described as Fe₂M0₃₋₄0₁₂₋₁₅−(H₂0)x and Fe(OH)₂HMo0₄−(H₂0)ₓ, respectively. In one experiment, the weight ratio of total molybdenum to total iron consumed between the two precipitation reactions was 2.2:1.0. It was found in some experiments that the ferrimolybdate product formed is gelatinous in texture, adherent to filtering surfaces but not sticky, can contain up to 80% moisture by weight, and is light yellow when precipitated at a pH of 2.3 and a dark brown when precipitated at a pH of 3.4.

It was further determined that the estimated time for the uranium polishing columns to reach saturation is 18-24 hours with “dirty” water and 48-60 hrs with “clean” water. The saturation point is defined as a uranium breakthrough concentration equivalent or greater than the average concentration measured in the daily composite samples for each plant.

It is expressly understood that any number of extraction apparatuses may be used with any number or resins to extract an number of materials from a fluid. The use of the preceding examples of uranium and molybdenum should not be construed as limiting, but rather as exemplary.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A system of extracting a plurality of materials from a solution, comprising:
A plurality of extraction devices, wherein each of the extraction device comprises a resin suspended above at least one screen, wherein a liquid is forced through the plurality of extraction devices, wherein each of the extraction devices removes at least one material from the fluid, and wherein the resin selected for each of the extraction devices is based upon the material for which that extraction device is designed to remove from the fluid.

2. The system of claim 1, wherein the extraction device is a column extractor.

3. The system of claim 1, wherein at least one of the extraction devices removes uranium from the fluid.

4. The system of claim 1, wherein at least one of the extraction devices removes molybdenum form the fluid.

5. The system of claim 1, wherein at least one of the extraction devices removes a transition metal from the fluid.

6. The system of claim 1, wherein at least one of the resins is a resin comprising a strong base type I anion.

7. The system of claim 1, wherein each of the extraction devices have a separate resin.

8. The system of claim 6, wherein at least one of the resins is a resin comprising a strong base type II anion.

9. A method, comprising:
selecting a number of extraction apparatuses for extracting a plurality of transitional metals from a fluid;
selecting at least one resin for the plurality of extraction apparatuses;
moving a liquid through the plurality of extraction apparatuses;
extracting at least one transition metal from the liquid; and
regenerating at least one of the plurality of extraction apparatuses.

10. The method of claim 9, wherein the at least one resin is a resin comprising a strong base anion.
